(19) United States
(12) Patent Application Publication
(10) Pub. No.: US 2023/0382255 A1
(43) Pub. Date: Nov. 30, 2023

(54) CLOSED-LOOP BATTERY MONITORING AND CHARGING SYSTEM

(71) Applicant: Textron Innovations Inc., Fort Worth, TX (US)

(72) Inventors: Mike Bryan Neus, Lewisville, TX (US); Jerome Wayne Powell, Mansfield, TX (US); Michael Collin Zreet, Fort Worth, TX (US)

(73) Assignee: Textron Innovations Inc., Fort Worth, TX (US)

(21) Appl. No.: 17/752,565

(22) Filed: May 24, 2022

(51) Int. Cl. B60L 53/62; H02J 7/00; B60L 58/12; B60L 58/16; B60L 58/24; B64D 45/00; H01M 10/0525; H01M 10/44; H01M 10/48; H01M 10/42

(52) U.S. Cl. CPC B60L 53/62; H02J 7/0063; H02J 7/0068; H02J 7/00712; H02J 7/0048; H02J 7/005; H02J 7/007194; B60L 58/12; B60L 58/16; B60L 58/24; B64D 45/00; H01M 10/0525; H01M 10/443; H01M 10/486; H01M 10/425; B60L 2200/10; B64D 2045/0085; H01M 2220/20; H01M 2010/4271

(57) ABSTRACT

One embodiment is an aircraft comprising a rechargeable main battery for providing power to a system load of the aircraft; power source for providing at least one of a voltage and a current for recharging the rechargeable main battery; and a controller module connected to the rechargeable main battery, the controller module configured to control a process of recharging the rechargeable main battery using the at least one of the voltage and the current according to a battery type of the rechargeable main battery without removing the rechargeable main battery from the aircraft.

### TECHNICAL FIELD

This disclosure relates in general to the field of vehicles that rely on rechargeable batteries and, more particularly, though not exclusively, to a closed-loop battery monitoring and charging system (CLBMCS) for such vehicles, including helicopters.

### BACKGROUND

Historical data and informal discussions with helicopter operators corroborate that the relatively short lives of rechargeable main batteries are a common issue. As an example, if a light helicopter main lithium iron phosphate (LFP) battery costs $6,500 to procure and is replaced every 1,000 flight hours, the material cost of the main battery alone contributes $6.50 per flight hour to the total aircraft operating cost. Main battery replacement is therefore not only an inconvenience but is a notable operating expense. Increasing the main battery life should be of high interest to both operators and designers of helicopters.

Rechargeable main batteries for helicopters may be designed for high electric charge capacity and to provide power over sustained periods of time. Such batteries may be characterized by a relatively high power-to-weight ratio and energy density. Smaller, lighter batteries may be desirable because they reduce the weight of an aircraft, such as a helicopter, thereby improving its performance.

In current helicopter electrical systems, the main battery is typically charged continuously at the voltage produced by the helicopter's electrical system, regardless of the current state of the battery (including state-of-charge (SOC), state-of-health (SOH), and/or battery temperature) and recommended charging voltage and/or current. Improperly performing the battery charging process may result in battery damage and/or a reduction in battery life.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIGS. 1A, 1B, and 2 illustrate perspective view example aircraft in accordance with embodiments described herein;

FIG. 3 illustrates a system block diagram of an example open-loop vehicle battery charging system in accordance with conventional embodiments;

FIG. 4 illustrates a system block diagram of an example CLBMCS in accordance with embodiments described herein;

FIG. 5 is a flowchart of example operations that may be performed by the CLBMCS of FIG. 4 in accordance with embodiments described herein; and

FIG. 6 is a block diagram illustrating an example system that may be configured to control operation of one or more portions of a CLBMCS in accordance with embodiments described herein.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this Specification, the terms “forward,” “aft,” “inboard,” and “outboard” may be used to describe relative relationship(s) between components and/or spatial orientation of aspect(s) of a component or components. The term “forward” may refer to a spatial direction that is closer to a front of an aircraft relative to another component or component aspect(s). The term “aft” may refer to a spatial direction that is closer to a rear of an aircraft relative to another component or component aspect(s). The term “inboard” may refer to a location of a component that is within the fuselage of an aircraft and/or a spatial direction that is closer to or along a centerline of the aircraft (wherein the centerline runs between the front and the rear of the aircraft) or other point of reference relative to another component or component aspect. The term “outboard” may refer to a location of a component that is outside the fuselage of an aircraft and/or a spatial direction that farther from the centerline of the aircraft or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying figures.

Embodiments described herein provide a CLBMCS to assure proper charging of rechargeable vehicle batteries, thereby to optimize the health and longevity thereof. Embodiments described herein utilize sensors and indicators to provide data for alerting ground and flight crew and for prompting condition based maintenance (CBM). Currently, the health of aircraft rechargeable batteries is not actively monitored and is not known during operation; rather, off-aircraft testing with specialized equipment is required to verify battery health and continued airworthiness.

Embodiments of the CLBMCS described herein integrate hardware and software to enable a “closed-loop” system for charging aircraft rechargeable batteries, providing alerts regarding SOH and SOC of such batteries, and for prompting CBM. Although embodiments are shown and described with reference to a main aircraft battery, it will be recognized that any battery that is recharged from on-board power systems (e.g., emergency lighting) may the benefit from the various features. The system described herein enables the charging cycle of a rechargeable battery to be monitored, controlled, and adjusted in accordance with original equipment manufacturer (OEM) specifications.

Embodiments described herein may provide crew alerts including feedback of overall battery condition which may require action. Additionally, CBM can be used to alert maintenance technicians regarding when battery maintenance is required to restore battery health that might otherwise to unnoticed.

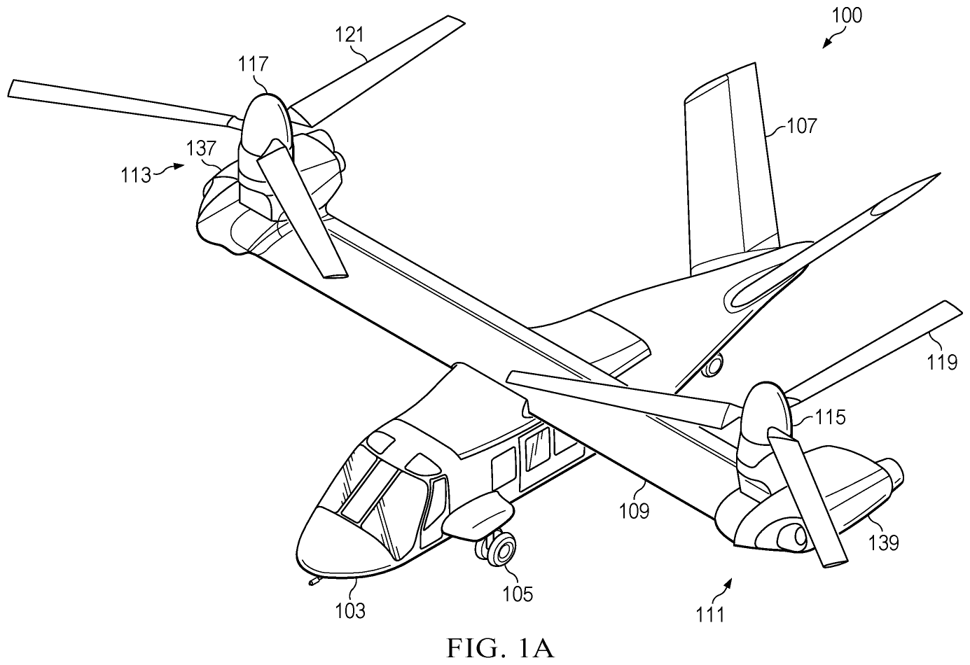

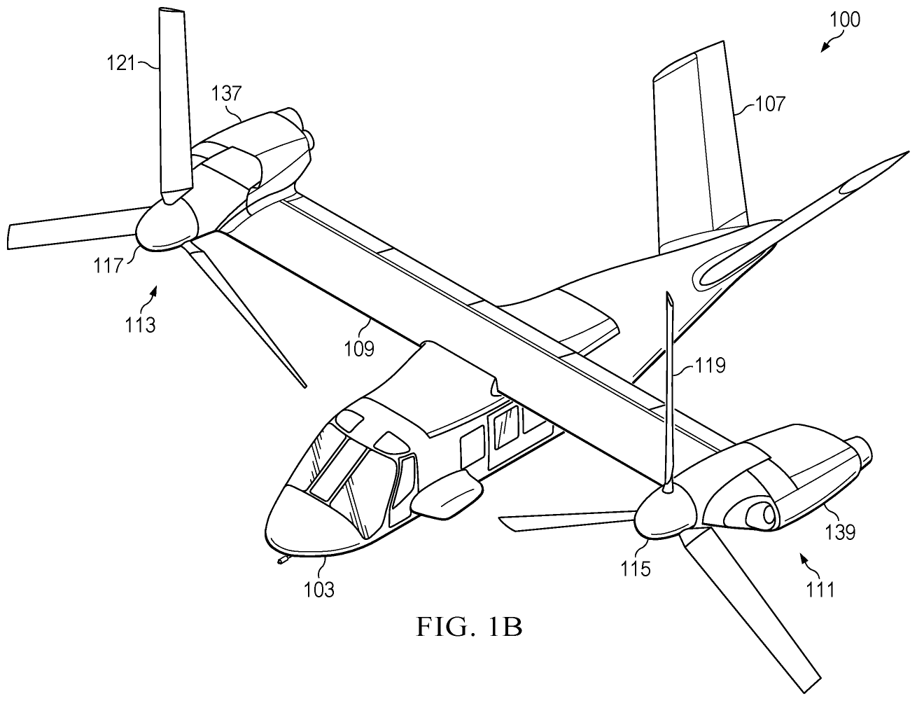

FIGS. 1A and 1B illustrate an exemplary aircraft, which in this case is a tiltrotor aircraft 100. Tiltrotor aircraft 100 may include a fuselage 103, a landing gear 105, a tail member 107, a wing 109, a drive system 111, and a drive system 113. Each drive system 111 and 113 includes a fixed engine 137 and fixed engine 139, respectively, and a proprotor 115 and 117, respectively. Each of the proprotors 115 and 117 is rotatable and has a plurality of rotor blades 119 and 121, respectively, associated therewith. The position of proprotors 115 and 117, as well as the pitch of rotor blades 119 and 121, can be selectively controlled in order to selectively control direction, thrust, and lift of the tiltrotor aircraft 100.

FIG. 1A illustrates the tiltrotor aircraft 100 in helicopter mode, in which proprotors 115 and 117 are positioned substantially vertical to provide a lifting thrust. FIG. 1B illustrates tiltrotor aircraft 100 in an airplane, or cruise, mode, in which proprotors 115 and 117 are positioned substantially horizontal to provide a forward thrust in which a lifting force is supplied by wing 109. It should be appreciated that tiltrotor aircraft can be operated such that proprotors 115 and 117 are selectively positioned between airplane mode and helicopter mode, which can be referred to as a conversion mode.

It will be recognized that, while embodiments will be described herein in the context of tiltrotor aircraft 100, the same embodiments may be implemented on other aircraft and/or rotorcraft. For example, an alternative embodiment of the tiltrotor aircraft 100 may include a quad tiltrotor that has an additional wing member aft of wing 109; the additional wing member can have additional drive systems similar to drive systems 111 and 113. In another embodiment, embodiments may be used in connection with an unmanned version of tiltrotor aircraft 100 and/or a variety of tiltrotor aircraft configurations.

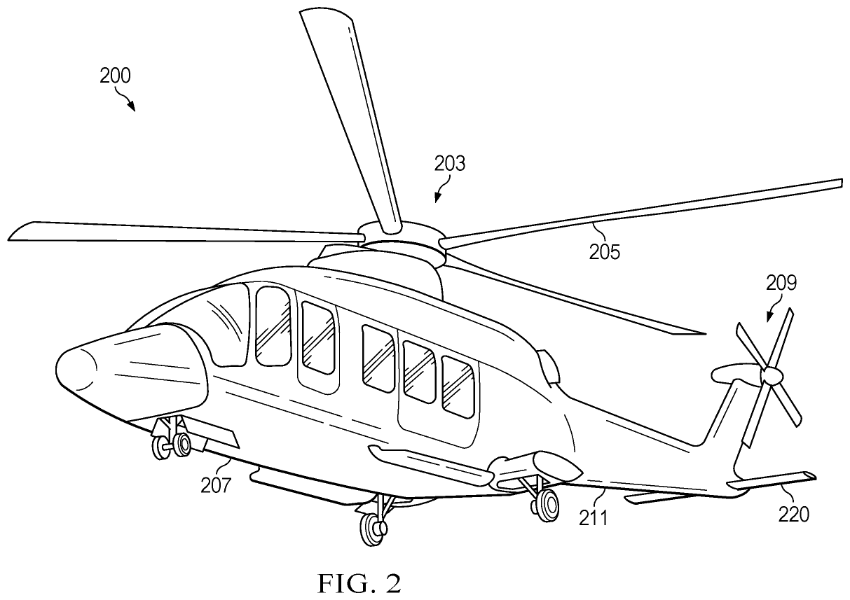

FIG. 2 illustrates another exemplary aircraft, which in this case is a rotorcraft 200. Rotorcraft 200 includes an airframe (hidden beneath an outer mold line of the rotorcraft) and a rotor system 203 coupled to the airframe and the engines of the drive system. The rotor system 203 includes with a plurality of rotor blades 205. The pitch of each rotor blade 205 can be managed or adjusted in order to selectively control direction, thrust, and lift of the rotorcraft 200. The rotorcraft 200 further includes a fuselage 207, tail rotor and anti-torque system 209, an empennage 211, and a tail structure 220, each of which is attached to the airframe. The tail structure 220 may be used as a horizontal stabilizer. Torque is supplied to rotor system 203 and anti-torque system 209 from engines 223 and 219.

It should be appreciated that the tiltrotor aircraft 100 of FIGS. 1A and 1B, and the rotorcraft 200 of FIG. 2 are merely illustrative of a variety of aircraft that can be used to implement embodiments of the present disclosure. Other aircraft implementations can include, for example, fixed wing airplanes, hybrid aircraft, unmanned aircraft, gyrocopters, a variety of helicopter configurations, and drones, among other examples. Moreover, it should be appreciated that even though aircraft are particularly well suited to implement embodiments of the present disclosure, the described embodiments can also be implemented using non-aircraft vehicles and devices.

Batteries are a chemical energy storage device. Main batteries used on a helicopter rely on a chemical process to generate electrical power. The primary components of a typical chemical battery include two dissimilar metals (a cathode and an anode), an electrolyte (typically an acidic, basic, or salt solution), and a case to contain everything. A single grouping of one cathode and one anode with electrolyte form one battery cell. As a single battery cell often produces less than the desired voltage, it is common for several cells to be connected in series within the case to provide the desired working voltage. The series connected cells are then electrically connected to terminals on the battery exterior to which an electrical load can be attached.

When an electrical load is placed on the battery's terminals, the anode material produces electrons, while the cathode accepts electrons. This results in current flow. As electrons flow, the chemical composition of the cathode and anode change. This process is referred to as discharging. When enough material is converted, these reactions can no longer occur at a rate that provides the demanded electrical energy. At this point, the battery is considered fully discharged.

Certain battery chemistries, including absorbed glass mat (AGM) and LFP, allow the discharge process to be reversed by “pushing” electric current into the cathode. This recharging process causes internal chemical reactions to reverse and restore battery materials to their prior state. When no more depleted material can return to a reactive state, the battery is considered fully charged. Charging a battery allows it to be reused rather than disposed of after being depleted.

During discharge of a lead acid battery, the cathode, made of lead dioxide (PbO₂), and the anode, made of lead (Pb), are both converted into lead sulfate (PbSO₄). The electrolyte, made of weak sulfuric acid (H₂SO₄), is also converted into water. For this chemical reaction to complete, electrons must move from the anode, through the electrical load, and into the cathode.

During charging, this process reverses to restore the cathode, anode, and electrolyte to their former state. Inevitably, some hydrogen and oxygen are liberated as a gas during charging. This explosive combination of gasses must be vented safely off the aircraft.

AGM batteries, including those found as main helicopter batteries, are a particular type of lead-acid battery. AGM batteries use a sponge-like glass mat to absorb and retain the electrolyte. This prevents spillage of the electrolyte and allows operation in nearly any orientation. AGM batteries are also sealed. This forces hydrogen and oxygen gasses generated during charging to be recombined internally back to water. A pressure relief valve is incorporated into the battery case to relieve internal pressure should gas generation exceed the battery's gas recombination capacity. The valve outlet is vented off the aircraft. These features result in AGM batteries occasionally being called recumbent gas, valve regulated lead-acid (VRLA), or sealed lead-acid (SLA) batteries.

In recent years, lithium-Ion batteries have received increased attention for use as main helicopter batteries. Whereas lead-acid refers to the chemical composition of a battery, Lithium-ion is a direct reference to the exchange of lithium ions within the battery as an integral component of the discharge and charging process. Lithium-ion therefore refers to a family of batteries whose actual internal chemistry and properties vary.

LFP is a relatively new type of lithium-Ion battery that has begun to make significant inroads for use in aviation. LFP batteries are substantially lighter than an equivalent lead-acid or nickel-cadmium (NiCd) batteries. LFP batteries also have a lower internal impedance than lead-acid or NiCd resulting in less voltage sag during engine starts. LFP batteries are also considered safer than other lithium-Ion technologies.

During discharge, LFP batteries utilize an iron phosphate (FePO⁴) cathode and a lithiated graphite (LiC₆) anode. Unlike a lead-acid battery, the electrolyte only transports ions and does not participate in the chemical reaction. As an LFP battery discharges, the cathode is converted to lithium iron phosphate (LiFePO₄) and the anode to graphite (C). Electrons must flow through the electrical load for the chemical reaction to complete.

During charging, the process reverses to restore the cathode and anode to their former state. Unlike an AGM battery, no potentially hazardous gasses are generated during routine charging or any other operating mode. Venting an LFP main battery overboard is still necessary in the unlikely event of thermal runaway or fire.

As a battery ages, the internal chemical reactions become less efficient. During routine charging and discharging, the cathode and anode slowly undergo physical changes as a result of the transfer of electrons, ions, and chemical processes. These changes are not always 100% reversible. Once enough damage has accumulated, the internal battery electro-chemical reactions may cease to occur at an acceptable rate. The reduction of available reactive material results in reduced battery capacity. At some point, the battery reaches its end of life and requires replacement.

Failures due to age cannot be eliminated as they are a natural consequence of use. However, certain underlying failure modes can be accelerated through improper use, improper charging, and/or neglect.

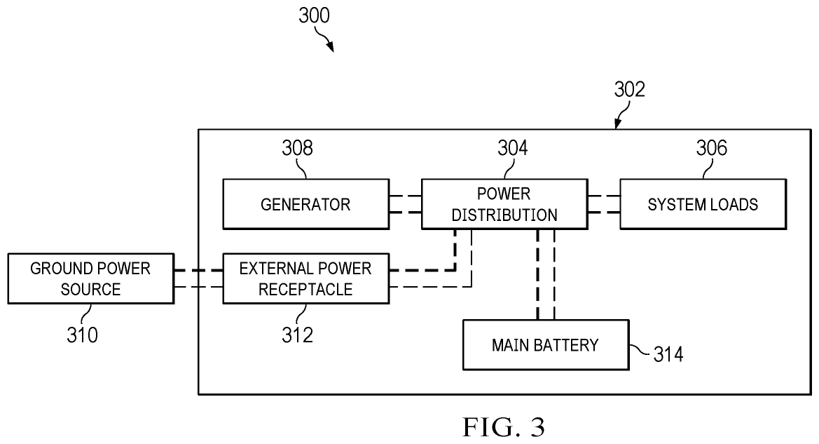

Referring now to FIG. 3, illustrated therein is a system block diagram of a conventional open-loop vehicle battery charging system 300 applied to a vehicle electrical system 302 in accordance with example embodiments. As shown in FIG. 3, the vehicle electrical system 302 includes a power distribution system 304 for providing power to system loads 306 from a selected power source. The power distribution system 304 may select to provide power to the system loads 306 from one or more of a generator 308, a ground power source 310 via an electrical receptacle 312, and a main battery 314. Although not shown for the sake of simplicity, it will be recognized that other power sources may be included in the vehicle electrical system 302 and connected to the power distribution system 304. Main battery 314 may be any type of rechargeable battery described above as well as any other type of rechargeable battery appropriate for the particular application.

When the main battery 314 is not being discharged (e.g., when the helicopter is on the ground using ground power or in the air using generator power (i.e., in flight)), current and/or voltage may be applied to appropriate terminals of the main battery 314 to charge the main battery as described above. The power source for charging the battery 314 may be selected by the power distribution system 304 and may include the generator 308 and/or the ground power source 310 via the electrical receptacle 312 (e.g., when the helicopter is grounded).

It will be recognized that the charging mechanism deployed in the system 300 shown in FIG. 3 lacks charge monitoring functionality, as well as charge control functionality; the battery 314 is connected to the selected power source and charged at whatever level of voltage and/or current is available and to whatever capacity that time permits.

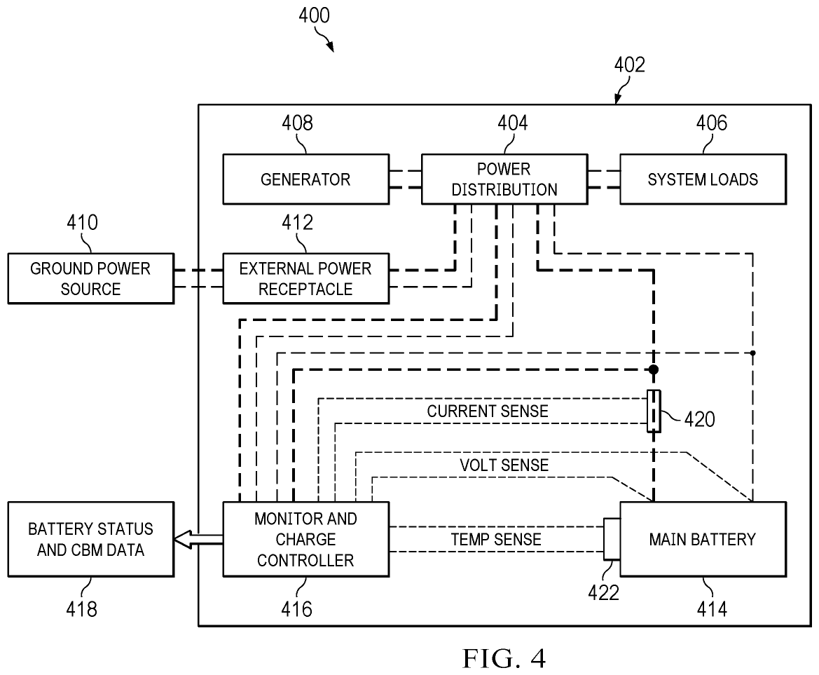

FIG. 4 illustrates a system block diagram of an example CLBMCS 400 applied to a vehicle electrical system 402 in accordance with features of embodiments described herein. As shown in FIG. 4, the vehicle electrical system 402 includes a power distribution system 404 for providing power to system loads 406 from a selected power source. The power distribution system 404 may select to provide power to the system loads 406 from one or more of a generator 408, a ground power source 410 via an electrical receptacle 412, and a main battery 414. Although not shown for the sake of simplicity, it will be recognized that other power sources may be included in the vehicle electrical system 402 and connected to the power distribution system 404. Main battery 414 may be any type of rechargeable battery described above as well as any other type of rechargeable battery appropriate for the particular application.

When the main battery 414 is not being discharged (e.g., when the helicopter is on the ground), current and/or voltage may be applied to appropriate terminals of the main battery 414 to charge the main battery as described above. The power source for charging the battery 414 may be selected by the power distribution system 404 and may include the generator 408 and/or the ground power source 410 via the electrical receptacle 412 (e.g., when the helicopter is grounded).

In accordance with features of embodiments described herein, the system 400 includes a battery monitor and charge controller (BMCC) 416 that outputs battery status and CBM data 418 as will be described. In a particular embodiment, BMCC 416 may receive battery current data from a current sensor 420, battery temperature data from a temperature sensor 422, and battery voltage data measured across terminals of the main battery 414 and may use the received data to perform battery monitoring and charge control functions as described herein. In particular, the BMCC 416 interprets the data from the battery sensors (e.g., sensors 420 and 422) to optimize the charging process based on battery status. The optimization may be based on parameters such as battery status and battery type to comply with charging algorithm specified by the battery OEM. The BMCC 416 provides battery status and CBM data 418 to other aircraft systems, for example. Battery status and CBM data 418 includes one or more of an indication of whether the battery 414 is charging or discharging, battery SOC, battery SOH, battery voltage (voltmeter), battery current (ammeter), and battery temperature.

It will be recognized that the power distribution system 404 cannot “back feed” the battery when the generator 408 or external power 412 are active. If power does flow from the power distribution system 404 to the main battery 414, the BMCC 416 cannot control the battery charging process. Additionally, the charging function of the BMCC 416 must be inhibited when battery power is being used to prevent the battery from attempting to charge itself.

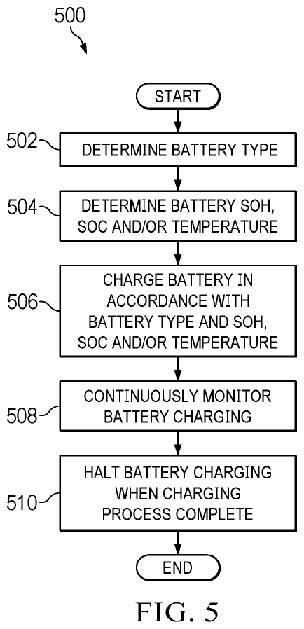

FIG. 5 is a flowchart 500 of example operations that may be performed by the BMCC 416 (FIG. 4) in accordance with features of embodiments described herein. It will be recognized that the operations shown in and described with reference to FIG. 5 are illustrative only and that fewer than all of the illustrated operations may be performed and/or additional operations as described elsewhere may be performed without departing from the sprit or scope of the disclosure.

In step 502, the battery type may be determined. As previously described, battery type information is useful in determining what type of charging profile is optimal for the battery. The battery type may be programmed into the system, may be provided by a human operator, or the system may include functionality to determine the battery type by other means.

In step 504, the state of the battery may be determined. The state of the battery may include battery SOH, battery SOC, battery voltage, battery current, and/or battery temperature.

In step 506, the battery is charged in accordance with the charging profile associated with the battery type and inconsideration of the state of the battery (e.g., SOH, SOC, temperature).

In step 508, the charging process is continuously monitored using current, voltage, and/or temperature information from the system sensors.

In step 510, the battery charging process is adjusted or halted in accordance with battery charging specifications associated with the determined battery type when it is determined (based on the continuous monitoring) that the charging process is complete. For example, charging of certain types of batteries need not be completely stopped once charging is complete.

It will be recognized that during charging, the battery is disconnected from power distribution and charge current and charge voltage are controlled by the BMCC.

Additionally and/or alternatively, in a nominal discharge operation, when the engine is starting and in other states requiring vehicle power, charging of the battery by the BMCC is halted and the battery is connected directly to the power distribution system.

In some embodiments described herein, useful battery life of a vehicle may be extended through application of the correct charging procedure depending on the battery type. For example, NiCad batteries require a two stage constant current recharging process. AGM batteries require a three stage (bulk/absorb/float) recharging process. Lithium batteries require a two stage constant current constant voltage recharging process.

In some embodiments, charging voltage and current may be adjusted in real-time based on temperature, voltage, and state of charge in accordance with battery OEM charging procedures.

In some embodiments, various battery protections, such as over-discharge, short circuit, over-temperature, etc., may be incorporated into the closed-loop system described herein. Continuous real-time battery health monitoring, such as provided by the closed-loop system described herein, may eliminate the need for scheduled battery testing to establish battery air worthiness. Moreover, periodic capacity checks and deep discharge recovery procedures may be performed by the BMCC 416 (FIG. 4)_without removing the battery and without support equipment.

In some embodiments, while on battery power and on ground, crew alerts/alarms may be provided based on battery state(s) of charge at which action should be taken (e.g., plug in ground power) or inhibited (e.g., engine starting at low charge levels). Additionally, aircraft systems may shut down before a deep discharge occurs to avoid battery damage.

In some embodiments, battery health can be determined from the gathered data and maintenance activities correlated. For example:
Low State of Charge: Ground charging required
X Days Since Last Full Charge: Ground charging required
X Days Since Last Capacity Check: Capacity check required
Deep Discharge Occurred: Battery recovery procedure required
Charge Cycle that does not match expected cycle (based on state of charge): Battery is end of life
Battery exhibits high resistance (lower than expected voltage under load): Battery is end of life

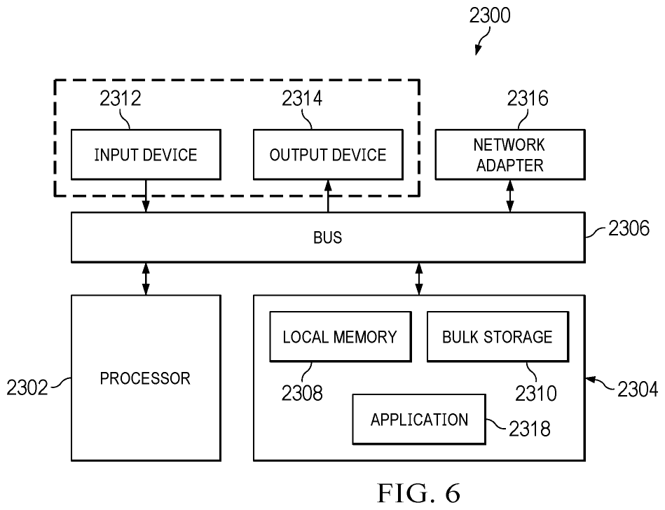

FIG. 6 provides a block diagram illustrating an example processing system 2300 that may be configured to perform one or more of the operations described above according to some embodiments of the present disclosure. For example, the processing system 2300 may be configured to implement all or portions of the CLBMCS as described herein.

As shown in FIG. 6, the processing system 2300 may include at least one processor 2302, e.g., a hardware processor 2302, coupled to memory elements 2304 through a system bus 2306. As such, the processing system may store program code within memory elements 2304. Further, the processor 2302 may execute the program code accessed from the memory elements 2304 via a system bus 2306. In one aspect, the processing system may be implemented as a computer that is suitable for storing and/or executing program code. It should be appreciated, however, that the processing system 2300 may be implemented in the form of any system including a processor and a memory that is capable of performing the functions described within this disclosure.

In some embodiments, the processor 2302 can execute software or an algorithm to perform the activities as discussed in the present disclosure. The processor 2302 may include any combination of hardware, software, or firmware providing programmable logic, including by way of non-limiting example a microprocessor, a digital signal processor (DSP), a field-programmable gate array (FPGA), a programmable logic array (PLA), an application specific IC (ASIC), or a virtual machine processor. The processor 2302 may be communicatively coupled to the memory element 2304, for example in a direct-memory access (DMA) configuration, so that the processor 2302 may read from or write to the memory elements 2304.

In general, the memory elements 2304 may include any suitable volatile or non-volatile memory technology, including double data rate (DDR) random access memory (RAM), synchronous RAM (SRAM), dynamic RAM (DRAM), flash, read-only memory (ROM), optical media, virtual memory regions, magnetic or tape memory, or any other suitable technology. Unless specified otherwise, any of the memory elements discussed herein should be construed as being encompassed within the broad term “memory.” The information being measured, processed, tracked or sent to or from any of the components of the processing system 2300 could be provided in any database, register, control list, cache, or storage structure, all of which can be referenced at any suitable timeframe. Any such storage options may be included within the broad term “memory” as used herein. Similarly, any of the potential processing elements, modules, and machines described herein should be construed as being encompassed within the broad term “processor.” Each of the elements shown in the present figures can also include suitable interfaces for receiving, transmitting, and/or otherwise communicating data or information in a network environment so that they can communicate with, e.g., the processing system 2300.

In certain example implementations, portions of mechanisms described herein may be implemented by logic encoded in one or more tangible media, which may be inclusive of non-transitory media, e.g., embedded logic provided in an ASIC, in DSP instructions, software (potentially inclusive of object code and source code) to be executed by a processor, or other similar machine, etc. In some of these instances, memory elements, such as e.g., the memory elements 2304 shown in FIG. 6, can store data or information used for the operations described herein. This includes the memory elements being able to store software, logic, code, or processor instructions that are executed to carry out the activities described herein. A processor can execute any type of instructions associated with the data or information to achieve the operations detailed herein. In one example, the processors, such as e.g., the processor 2302 shown in FIG. 6, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., an FPGA, a DSP, an erasable programmable read-only memory (EPROM), an electrically erasable programmable read-only memory (EEPROM)) or an ASIC that includes digital logic, software, code, electronic instructions, or any suitable combination thereof.

The memory elements 2304 may include one or more physical memory devices such as, for example, local memory 2308 and one or more bulk storage devices 2310. The local memory may refer to RAM or other non-persistent memory device(s) generally used during actual execution of the program code. A bulk storage device may be implemented as a hard drive or other persistent data storage device. The processing system 2300 may also include one or more cache memories (not shown) that provide temporary storage of at least some program code in order to reduce the number of times program code must be retrieved from the bulk storage device 2310 during execution.

As shown in FIG. 6, the memory elements 2304 may store an application 2318. In various embodiments, the application 2318 may be stored in the local memory 2308, the one or more bulk storage devices 2310, or apart from the local memory and the bulk storage devices. It should be appreciated that the processing system 2300 may further execute an operating system (not shown in FIG. 6) that can facilitate execution of the application 2318. The application 2318, being implemented in the form of executable program code, can be executed by the processing system 2300, e.g., by the processor 2302. Responsive to executing the application, the processing system 2300 may be configured to perform one or more operations or method steps described herein.

Input/output (I/O) devices depicted as an input device 2312 and an output device 2314, optionally, can be coupled to the processing system. Examples of input devices may include, but are not limited to, a keyboard, a pointing device such as a mouse, or the like. Examples of output devices may include, but are not limited to, a monitor or a display, speakers, or the like. In some embodiments, the output device 2314 may be any type of screen display, such as plasma display, liquid crystal display (LCD), organic light emitting diode (OLED) display, electroluminescent (EL) display, or any other indicator, such as a dial, barometer, or LEDs. In some implementations, the system may include a driver (not shown) for the output device 2314. Input and/or output devices 2312, 2314 may be coupled to the processing system either directly or through intervening I/O controllers.

In an embodiment, the input and the output devices may be implemented as a combined input/output device (illustrated in FIG. 6 with a dashed line surrounding the input device 2312 and the output device 2314). An example of such a combined device is a touch sensitive display, also sometimes referred to as a “touch screen display” or simply “touch screen.” In such an embodiment, input to the device may be provided by a movement of a physical object, such as e.g., a stylus or a finger of a user, on or near the touch screen display.

A network adapter 2316 may also, optionally, be coupled to the processing system to enable it to become coupled to other systems, computer systems, remote network devices, and/or remote storage devices through intervening private or public networks. The network adapter may comprise a data receiver for receiving data that is transmitted by said systems, devices and/or networks to the processing system 2300, and a data transmitter for transmitting data from the processing system 2300 to said systems, devices and/or networks. Modems, cable modems, and Ethernet cards are examples of different types of network adapter that may be used with the processing system 2300.

Example 1 is an aircraft comprising a rechargeable main battery for providing power to a system load of the aircraft; a power source for providing at least one of a voltage and a current for recharging the rechargeable main battery; and a controller module connected to the rechargeable main battery, the controller module configured to control a process of recharging the rechargeable main battery using the at least one of the voltage and the current according to a battery type of the rechargeable main battery without removing the rechargeable main battery from the aircraft.

Example 2 provides the aircraft of example 1, wherein the controller module is further configured to control the recharging process according to at least one of a state of health (SOH) of the battery, a state of charge (SOC) of the battery, and a temperature of the battery.

Example 3 provides the aircraft of example 1, wherein the controller module is further configured to monitor at least one of a state of health (SOH) of the battery, a state of charge (SOC) of the battery and a temperature of the battery during the recharging process.

Example 4 provides the aircraft of example 1, wherein the controller module is further configured to perform at least one of a battery capacity check and a deep discharge recovery process while the main rechargeable battery remains in situ.

Example 5 provides the aircraft of example 1, wherein the rechargeable main battery is a nickel cadmium battery and the recharging process is a two-state constant current process.

Example 6 provides the aircraft of example 1, wherein the rechargeable main battery is an absorbed glass mat battery and the recharging process is a three stage process including a bulk state, an absorb state, and a float state.

Example 7 provides the aircraft of example 1, wherein the rechargeable main battery is a lithium battery and the recharging process is a two stage constant current constant voltage process.

Example 8 provides the aircraft of example 1, wherein the power source comprises an external power source.

Example 9 provides the aircraft of example 1, wherein the controller module is further configured to provide at least one of a battery status alert and a condition based maintenance (CBM) alert.

Example 10 provides the aircraft of example 1, further comprising at least sensor for providing sensor data to the controller module.

Example 11 provides the aircraft of example 10, wherein the at least one sensor comprises at least one of a voltage sensor, a temperature sensor, and a current sensor.

Example 12 provides a helicopter comprising a battery for providing power to a system load of the aircraft; a controller module connected to the battery, the controller module configured to determine a battery type of the battery; determine a state of the battery while the battery remains in situ; monitor at least one of a battery temperature, a battery current, and a battery voltage; provide an alert based on the determined state of the battery, wherein the alert comprises at least one of a battery status alert and a condition based maintenance (CBM) alert; and control a process of charging the battery based on the determined battery type.

Example 13 provides the helicopter of example 12, wherein the state of the battery comprises at least one of a state of health (SOC) of the battery, a state of charge (SOC) of the battery and a temperature of the battery.

Example 14 provides the helicopter of example 12, wherein the controller module is further configured to perform at least one of a battery capacity check and a deep discharge recovery process while the battery remains in situ.

Example 15 provides the helicopter of example 12, wherein the battery type comprises at least one of a nickel cadmium battery, an absorbed glass mat battery, and a lithium battery.

Example 16 provides the helicopter of example 15, wherein the recharging process comprises at least one of a two-state constant current process; a three stage process including a bulk state, an absorb state, and a float state; and a two stage constant current constant voltage process.

Example 17 provides a method for monitoring and charging a battery of a helicopter, the method comprising determining a battery type of the battery; monitoring a state of the battery, wherein the state of the battery comprises at least one of a battery state of health (SOH), a battery state of charge (SOC), a battery temperature, a battery voltage, and a battery current; and charging the battery in accordance with a charging profile associated with the battery type and the battery state.

Example 18 provides the method of example 17, further comprising providing an alert based on the state of the battery, wherein the alert comprises at least one of a battery status alert and a condition based maintenance (CBM) alert.

Example 19 provides the method of example 17, wherein the battery type comprises at least one of a nickel cadmium battery, an absorbed glass mat battery, and a lithium battery.

Example 20 provides the method of example 19, wherein the charging profile comprises at least one of a two-state constant current process; a three stage process including a bulk state, an absorb state, and a float state; and a two stage constant current constant voltage process.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru−RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the Specification and the claims are embodiment(s) of the present invention. Also, the phrases “at least one of A, B, and C” and “A and/or B and/or C” should each be interpreted to include only A, only B, only C, or any combination of A, B, and C.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

1. An aircraft comprising:
a rechargeable main battery for providing power to a system load of the aircraft;
power source for providing at least one of a voltage and a current for recharging the rechargeable main battery;
a controller module connected to the rechargeable main battery, the controller module configured to determine a battery type of the rechargeable main battery, control and monitor a process of recharging the rechargeable main battery using the at least one of the voltage and the current according to the battery type of the rechargeable main battery without removing the rechargeable main battery from the aircraft, and halt the process of recharging the rechargeable main battery when the rechargeable main battery is fully charged,
wherein the controller module is further configured to perform a deep discharge recovery process on the main rechargeable battery while the main rechargeable battery remains in situ.

2. The aircraft of claim 1, wherein the controller module is further configured to control the recharging process according to at least one of a state of health (SOH) of the battery, a state of charge (SOC) of the battery, and a temperature of the battery.

3. The aircraft of claim 1, wherein the controller module is further configured to monitor at least one of a state of health (SOH) of the battery, a state of charge (SOC) of the battery and a temperature of the battery during the recharging process.

4. The aircraft of claim 1, wherein the controller module is further configured to perform a battery capacity check while the main rechargeable battery remains in situ.

5. The aircraft of claim 1, wherein the rechargeable main battery is a nickel cadmium battery and the recharging process is a two-state constant current process.

6. The aircraft of claim 1, wherein the rechargeable main battery is an absorbed glass mat battery and the recharging process is a three stage process including a bulk state, an absorb state, and a float state.

7. The aircraft of claim 1, wherein the rechargeable main battery is a lithium battery and the recharging process is a two stage constant current constant voltage process.

8. The aircraft of claim 1, wherein the power source comprises an external power source.

9. The aircraft of claim 1, wherein the controller module is further configured to provide at least one of a battery status alert and a condition based maintenance (CBM) alert.

10. The aircraft of claim 1, further comprising at least sensor for providing sensor data to the controller module.

11. The aircraft of claim 10, wherein the at least one sensor comprises at least one of a voltage sensor, a temperature sensor, and a current sensor.

12. A helicopter comprising:
a battery for providing power to a system load of the aircraft;
a controller module connected to the battery, the controller module configured to:
determine a battery type of the battery;
determine a state of the battery while the battery remains in situ;
monitor at least one of a battery temperature, a battery current, and a battery voltage;
provide an alert based on the determined state of the battery, wherein the alert comprises at least one of a battery status alert and a condition based maintenance (CBM) alert;
control and monitor a process of charging the battery based on the determined battery type;
halt the process of charging the battery when the battery is fully charged; and
perform a deep discharge recovery process on the battery while the battery remains in situ.

13. The helicopter of claim 12, wherein the state of the battery comprises at least one of a state of health (SOC) of the battery, a state of charge (SOC) of the battery and a temperature of the battery.

14. The helicopter of claim 12, wherein the controller module is further configured to perform a battery capacity while the battery remains in situ.

15. The helicopter of claim 12, wherein the battery type comprises at least one of a nickel cadmium battery, an absorbed glass mat battery, and a lithium battery.

16. The helicopter of claim 15, wherein the recharging process comprises at least one of a two-state constant current process; a three stage process including a bulk state, an absorb state, and a float state; and a two stage constant current constant voltage process.

17. A method for monitoring and charging a battery of a helicopter, the method comprising:
determining a battery type of the battery;
monitoring a state of the battery, wherein the state of the battery comprises at least one of a battery state of health (SOH), a battery state of charge (SOC), a battery temperature, a battery voltage, and a battery current;
charging the battery in accordance with a charging profile associated with the battery type and the battery state;
halting the charging of the battery when the battery is fully charged; and
performing a deep discharge recovery process on the battery while the battery remains in situ.

18. The method of claim 17, further comprising providing an alert based on the state of the battery, wherein the alert comprises at least one of a battery status alert and a condition based maintenance (CBM) alert.

19. The method of claim 17, wherein the battery type comprises at least one of a nickel cadmium battery, an absorbed glass mat battery, and a lithium battery.

20. The method of claim 19, wherein the charging profile comprises at least one of a two-state constant current process; a three stage process including a bulk state, an absorb state, and a float state; and a two stage constant current constant voltage process.
